(19) United States
(12) Patent Application Publication
(10) Pub. No.: US 2011/0076012 A1
(43) Pub. Date: Mar. 31, 2011

(54) OPTICAL NETWORK TERMINAL AND METHOD FOR DETECTING TRANSMISSION ERROR IN OPTICAL NETWORK TERMINAL

(76) Inventors: Yu Sik Na, Seoul (KR); Byeong Chan Lee, Yongin-si (KR)

(21) Appl. No.: 12/889,771

(22) Filed: Sep. 24, 2010

(30) Foreign Application Priority Data
Sep. 29, 2009 (KR) 10-2009-0092298

(51) Int. Cl. H04B 10/08

(52) U.S. Cl. 398/23

(57) ABSTRACT

Provided are an optical network terminal (ONT) and a method for the ONT to detect an optical transmission error. The ONT is connected with an optical line termination (OLT) and constituting a passive optical network (PON), and includes an optical transmitter configured to transmit an optical signal to the OLT, an error detector configured to detect an error of the optical transmitter; and a controller configured to transmit an error message to the OLT through the optical transmitter when the error detector detects an error of the optical transmitter.

### TECHNICAL FIELD

The described technology relates generally to an optical network terminal (ONT) and a method for the ONT to detect an optical transmission error.

### BACKGROUND

FIG. 1 is a block diagram of a passive optical network (PON). A PON 100 to shown in FIG. 1 as an example is an optical subscriber network architecture providing an optical-fiber-based high-speed service to companies or even general homes. The PON 100 uses a splitter 130 in an optical cable, thereby enabling one optical line termination (OLT) 110 to access several optical network terminals (ONTs) 120, 122 and 124. PONs include time division multiplexing (TDM)(A)-PONs which employ a TDM scheme and wavelength division multiplexing (WDM)(A)-PONs which employ a WDM technique. The TDM(A)-PONs include asynchronous transfer mode (ATM)-PONs based on ATM, gigabit Ethernet (G)E-PONs, and G-PONs which use a general frame protocol.

Meanwhile, in the PON 100 employing the TDM scheme, data is exchanged between the OLT 110 and the ONTs 120, 122 and 124 as follows. After the OLT 110 inserts the identifier of a registered ONT in a preamble of a frame and sends the frame to the registered ONT downstream, the ONT sends only the frame having the identifier of the ONT to a user interface (UI). On the other hand, when the OLT 110 dynamically assigns upstream time slots to all the ONTs 120, 122 and 124, each of the ONTs 120, 122 and 124 transmits data to the OLT 110 during the time slot assigned to the ONT itself upstream.

### SUMMARY

Embodiments provide an optical network terminal (ONT) and a method for the ONT to detect an optical transmission error.

In one embodiment, an ONT connected with an OLT and constituting a passive optical network (PON) is provided. The ONT includes: an optical transmitter configured to transmit an optical signal to the OLT; an error detector configured to detect an error of the optical transmitter; and a controller configured to transmit an error message to the OLT through the optical transmitter when the error detector detects an error of the optical transmitter.

In another embodiment, a method for an ONT connected with an OLT and constituting a PON to detect an optical transmission error is provided. The method includes: transmitting an optical signal to the OLT; monitoring the transmitted optical signal to generate an optical output state signal; comparing the generated optical output state signal and an optical transmission enable signal to detect the optical transmission error; and transmitting an error message to the OLT when the optical transmission error is detected.

The Summary is provided to introduce a selection of concepts in a simplified form that are further described below in the Detailed Description. The Summary is not intended to identify key features or essential features of the claimed subject matter, nor is it intended to be used as an aid in determining the scope of the claimed subject matter.

### BRIEF DESCRIPTION OF THE DRAWINGS

The above and other features and advantages of the present disclosure will become more apparent to those of ordinary skill in the art by describing in detail example embodiments thereof with reference to the attached drawings in which:

FIG. 1 is a block diagram of a passive optical network (PON).

FIG. 2 is a block diagram illustrating an operation in which an optical line termination (OLT) assigns time slots to respective optical network terminals (ONTs) and receives data from the ONTs upstream;

FIG. 3 is a block diagram illustrating an ONT according to an embodiment of the present disclosure;

FIG. 4 is a block diagram illustrating an error detector of FIG. 3;

FIG. 5 is a flowchart illustrating a method of detecting an optical transmission error according to an embodiment of the present disclosure;

FIG. 6 is a flowchart illustrating a method of detecting an optical transmission error according to another embodiment of the present disclosure; and

FIG. 7 is a flowchart illustrating a method of detecting an optical transmission error according to still another embodiment of the present disclosure.

### DETAILED DESCRIPTION

It will be readily understood that the components of the present disclosure, as generally described and illustrated in the Figures herein, could be arranged and designed in a wide variety of different configurations. Thus, the following more detailed description of the embodiments of apparatus and methods in accordance with the present disclosure, as represented in the Figures, is not intended to limit the scope of the disclosure, as claimed, but is merely representative of certain examples of embodiments in accordance with the disclosure. The presently described embodiments will be best understood by reference to the drawings, wherein like parts are designated by like numerals throughout.

Meanwhile, terms used herein are to be understood as follows.

It will be understood that, although the terms first, second, etc. may be used herein to describe various elements, these elements should not be limited by these terms. These terms are only used to distinguish one element from another. For example, a first element could be termed a second element, and, similarly, a second element could to be termed a first element, without departing from the scope of the present disclosure.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

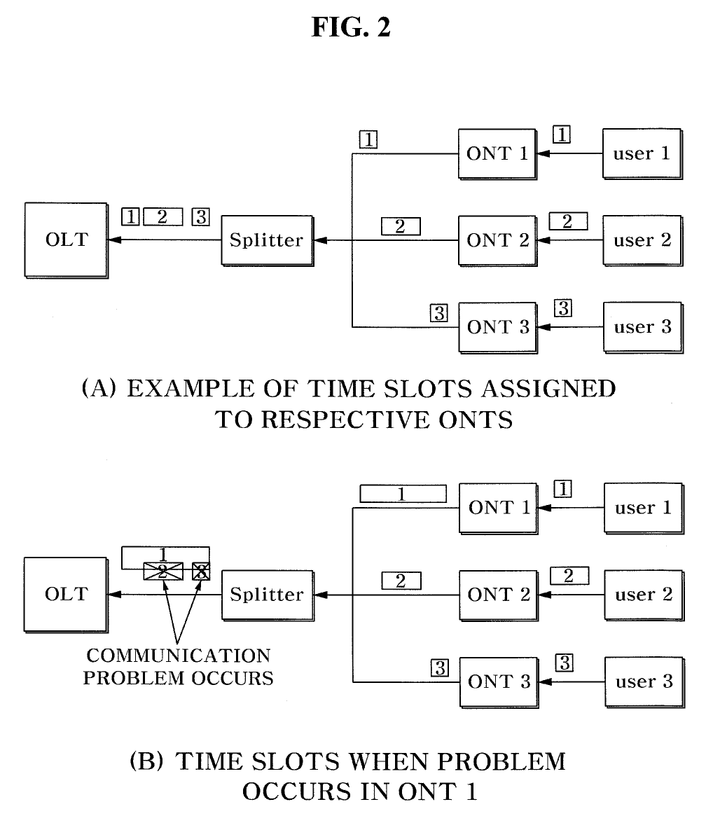

FIG. 2 is a block diagram illustrating an operation in which an optical line termination (OLT) assigns time slots to respective optical network terminals (ONTs) and receives data from the ONTs upstream.

FIG. 2(A) illustrates an example in which an OLT assigns time slots 1, 2 and 3 to ONTs 1, 2 and 3 and receives data from the respective ONTs 1, 2 and 3. FIG. 2(B) illustrates an example in which an optical output of the ONT 1 keeps occupying the line of the ONT 1 exclusively due to a problem of an optical module. In this way, when a laser is kept on regardless of a laser control signal due to a problem of an optical module, a laser of an optical module is kept on due to malfunction of a laser control signal of a specific ONT, or a laser control signal and an optical module control signal are set to be opposite to each other, one ONT occupies the entire upstream time slots. Thus, an OLT considers that all ONTs including the problematic ONT do not make correct responses, and releases the registration of all the ONTs to block upstream access.

The OLT cannot know in which ONT a problem has occurred. For this reason, the OLT needs to check each of all the ONTs, and thus normal ONTs cannot receive service until the OLT finds the ONT in which the problem has occurred. To solve this problem, an ONT 120 according to an embodiment of the present disclosure detects an error of an optical transceiver module by itself. And, when an error is detected, the ONT 120 transmits an error detection message to an OLT to inform the OLT of the error.

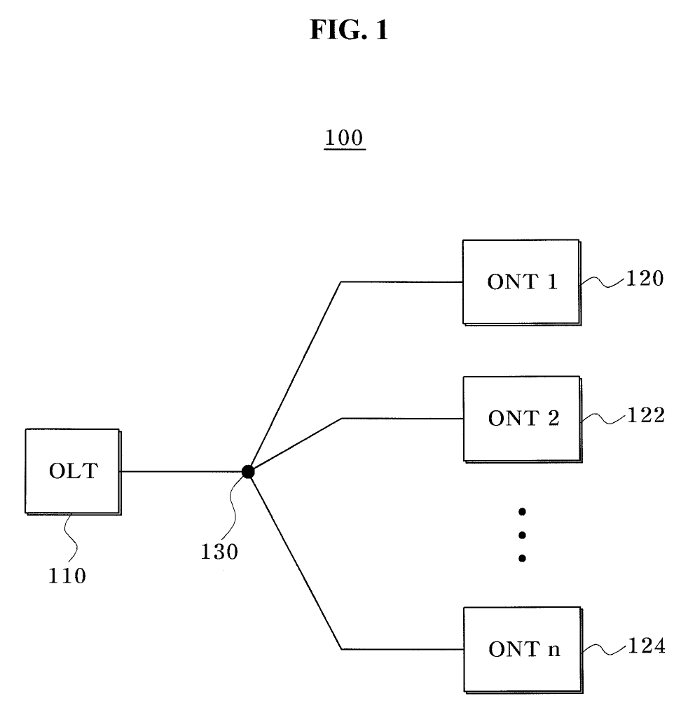

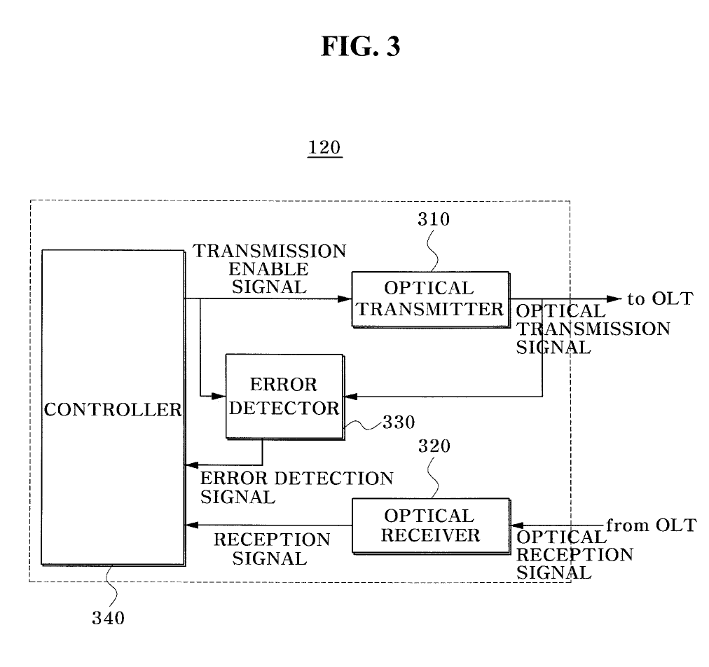

FIG. 3 is a block diagram illustrating an ONT according to an embodiment of the present disclosure. Referring to FIG. 3, the ONT 120 includes an optical transmitter 310, an optical receiver 320, an error detector 330, and a controller 340. As shown in FIG. 1, the ONT 120 is connected with an OLT 110 and constitutes a passive optical network (PON) 100. The OLT 110 assigns a line to the ONT 120 according to a time division multiplexing (TDM) scheme, as shown in FIG. 2.

The optical transmitter 310 transmits an optical signal to the OLT 110 according to the control of the controller 340. In an embodiment, the optical transmitter 310 can be implemented by a laser diode which outputs an optical signal and a laser driving unit which drives the laser diode according to an optical transmission enable signal received from the controller 340.

The optical receiver 320 receives an optical signal from the OLT 110. In an embodiment, the optical receiver can be implemented by a photodiode which receives and converts the optical signal into an electrical signal and an amplifier which amplifies the electrical signal and transfers the amplified electrical signal to the controller 340.

In an embodiment, the optical transmitter 310 and the optical receiver 320 may be implemented by one optical transceiver.

The error detector 330 detects an error of the optical transmitter 310. An error is detected, for example, when a laser is continuously output from the laser diode due to a problem of the optical transmitter 310, when the optical signal output from the optical transmitter 310 is opposite to the optical transmission enable signal transferred from the controller 340, and so on. Like this, the error detector 330 detects an error in which a laser output from the optical transmitter 310 is not the same as the optical transmission enable signal.

When the error detector 330 detects an error, the controller 340 transmits an error message to the OLT 110 through the optical transmitter 310. The ONT 120 can detect an error by itself and also informs the OLT 110 of the error, so that the error can be rapidly handled. When the ONT 120 detects an error by itself and informs the OLT 110 of the error, the processing speed is improved compared to a conventional method in which the OLT 110 detects an error of the ONT 120. When the OLT 110 attempts to detect an error, the OLT 110 needs to periodically monitor the respective ONTs 120 connected to the OLT 110 itself, and thus much time and effort are required.

Also, the OLT 110 can recognize which ONT has what problem through the error message, and rapidly take appropriate steps such as immediately repairing or changing a problematic ONT. Although the ONT 120 can rapidly detect its own error, if the ONT 120 does not inform the OLT 110 of the error, the OLT 110 cannot know a reason for which the ONT 120 in which the error has occurred is cut off and it is difficult to cope with the error.

The error message indicates that an error has occurred at the optical transmitter 310 of the specific ONT 120, and may include details of the error and the identifier of the ONT 120. As an example, the error message may be a dying gasp message which can be transmitted without external power supply. As another example, the error message may be defined in a standard for an immediate report to the OLT 110 and transmitted according to an ONT Management and Control Interface (OMCI) used in a PON or Physical Layer Operations, administration and Maintenance (PLOM) used in a PON. However, the error message is not limited to the examples and can have any forms.

The controller 340 according to an embodiment can power down the optical transmitter 310 when the error detector 330 detects an error. For example, the controller 340 can generate a power supply cut-off signal for the optical transmitter 310 or control signal to prevent a signal from being transmitted from the optical transmitter 310 in response to an error detection signal, which indicates that an error has been detected, received from the error detector 330. When an error occurs, the controller 340 cuts off power supply of the optical transmitter 310 by itself, thereby preventing the optical transmitter 310 in which the error has occurred from continuously outputting an optical signal and a communication problem of the other normal ONTs 122 and 124 sharing the same optical line with the ONT 120. In an embodiment, the controller 340 may cut off power supply of the ONT 120 instead of the optical transmitter 310.

The controller 340 according to another embodiment can power down the optical transmitter 310 when the optical transmitter 320 cannot receive a response message to the error message from the OLT 110. When the error message is received, the OLT 110 according to an embodiment can transmit a response message to the error message to the ONT 120. The response message may be a control message to cut off power supply of the optical transmitter 310 or a control message to prevent a signal from being transmitted from the optical transmitter 310. The controller 340 receiving the response message can control the ONT 120 according to the response message. When the response message is not received from the OLT 110 for a threshold time, the controller 340 can cut off power supply of the optical transmitter 310 by itself. The threshold time can be set or changed (e.g., three seconds) in advance by a network administrator according to system requirements, etc., and a value fixed when the ONT 120 is produced may be set as a default.

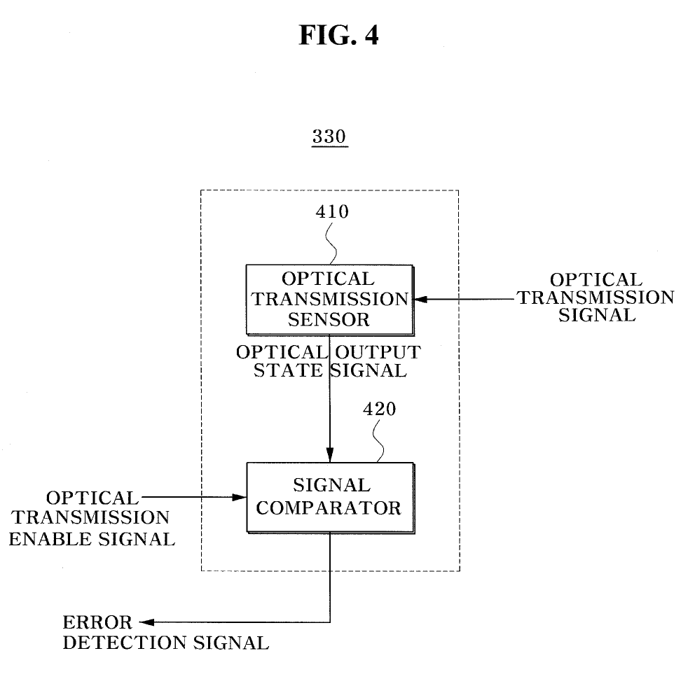

FIG. 4 is a block diagram illustrating an error detector of FIG. 3. Referring to FIG. 4, the error detector 330 includes an optical transmission sensor 410 and a signal comparator 420.

The optical transmission sensor 410 monitors an optical signal output by the optical transmitter 310 and generates an optical output state signal indicating an optical output state. For example, the optical transmission sensor 410 outputs a first signal (e.g., high) as the optical output state signal when the optical transmitter 310 outputs an optical signal, and a second signal (e.g., low) as the optical output state signal when the optical transmitter 310 is not outputting an optical signal. In an embodiment, the optical transmission sensor 410 may include a photodiode which senses an optical signal emitted from the laser diode of the optical transmitter 310 and converts the optical signal into an electrical signal.

The signal comparator 420 compares the optical output state signal received from the optical transmission sensor 410 and an optical transmission enable signal received from the controller 340, thereby detecting an error. Since the optical transmitter 310 outputs an optical signal according to the optical transmission enable signal, an optical output state of the optical signal actually output from the optical transmitter 310 and sensed by the optical transmission sensor 410 is the same as a state of the optical transmission enable signal when there is no error at the optical transmitter 310. Thus, the signal comparator 420 compares the optical output state signal and the optical transmission enable signal, and determines that there is an error to output an error detection signal indicating that an error has occurred when the optical transmission enable signal has an enable (e.g., high) value but the optical output state signal has a second signal (low) value, or when the optical transmission enable signal has a disable (e.g., low) value but the optical output state signal has a first signal (high) value. In an embodiment, the signal comparator can be implemented by an exclusive OR (XOR) gate which has the optical output state signal and the optical transmission enable signal as inputs and the error detection signal as an output. Here, the error detection signal has a high value (1) when there is an error, and a low value (0) when there is no error. In an embodiment, the error detection signal may have reverse values. The signal comparator 420 provides the output error detection signal to the controller 340.

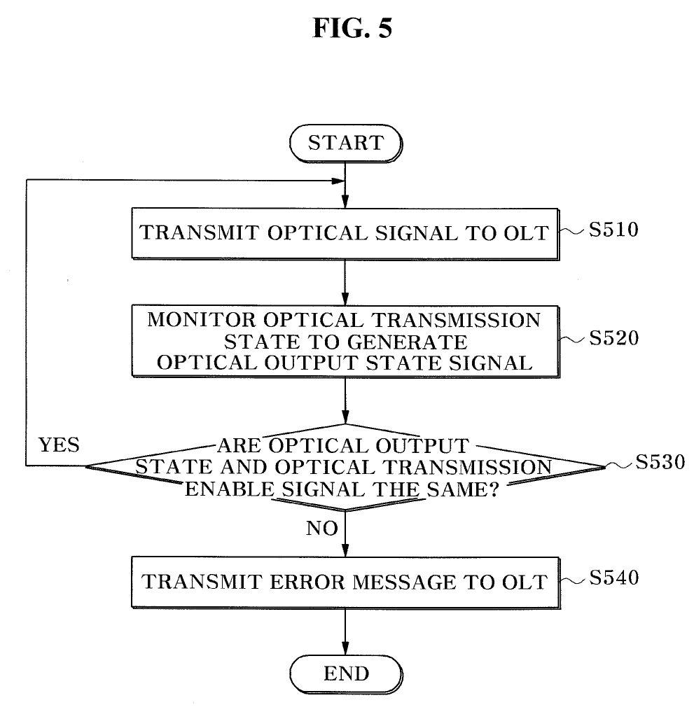

FIG. 5 is a flowchart illustrating a method of detecting an optical transmission error according to an embodiment of the present disclosure. A method for the ONT 120 to detect an optical transmission error will be described below with reference to FIGS. 3 to 5. Since the ONT 120 of FIG. 3 implemented in time series also corresponds to this embodiment, the above description of the ONT 120 is applied to this embodiment.

The ONT 120 is one of a plurality of ONTS connected with the OLT 110 and constituting the PON 100, as shown in FIG. 1. The OLT 110 assigns lines to the ONTs according to the TDM scheme. The ONT 120 transmits an optical signal to the OLT 110 (S510). For example, the ONT 120 can output the optical signal using a laser diode. The ONT 120 monitors the transmitted optical signal and generates an optical output state signal (S520). Using a photodiode, the ONT 120 can sense and convert the transmitted optical signal into an electrical signal. For example, the ONT 120 can convert an optical output state into an electrical logic signal having a high value (1) when an optical signal is output, and an electrical logic signal having a low value (0) when an optical signal is not output. The ONT 120 compares the optical output state signal converted into the electrical logic signal and an optical transmission enable signal, thereby determining whether the two values are the same (S530). When the two values are not the same, the ONT 120 determines that an error has occurred in optical transmission. When an optical transmission error is detected, the ONT 120 transmits an error message to the OLT 110 (S540).

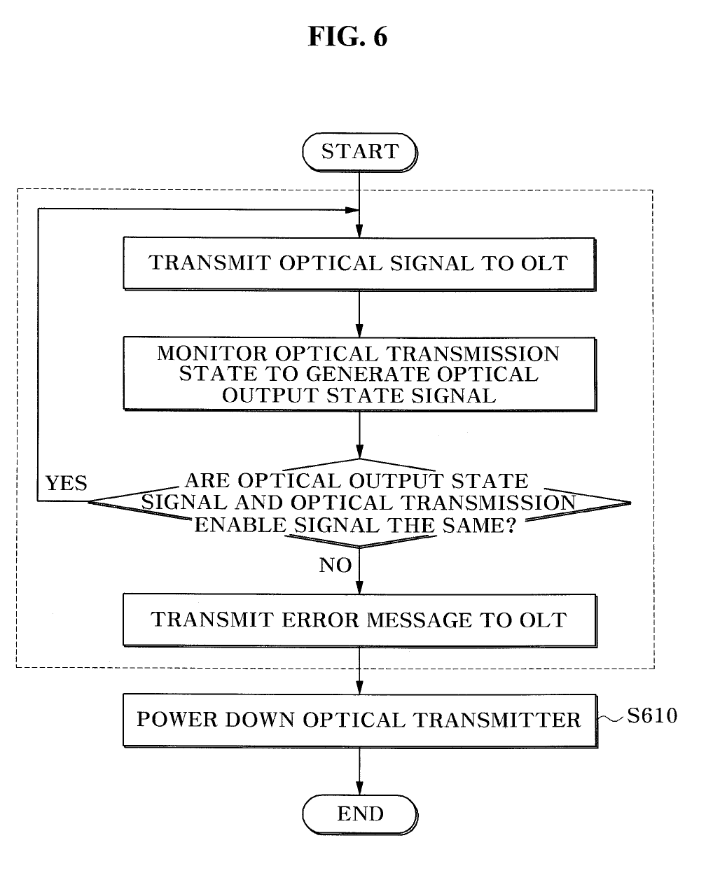

FIG. 6 is a flowchart illustrating a method of detecting an optical transmission error according to another embodiment of the present disclosure. The method according to the other embodiment includes a step (S610) in which the ONT 120 powers down its optical transmitter 310 when an optical transmission error is detected in step 530. Here, the ONT 120 may transmit an error message to the OLT 110 before power supply of the optical transmitter 310 is cut off, or the error message may be a dying gasp message which can be transmitted without external power supply.

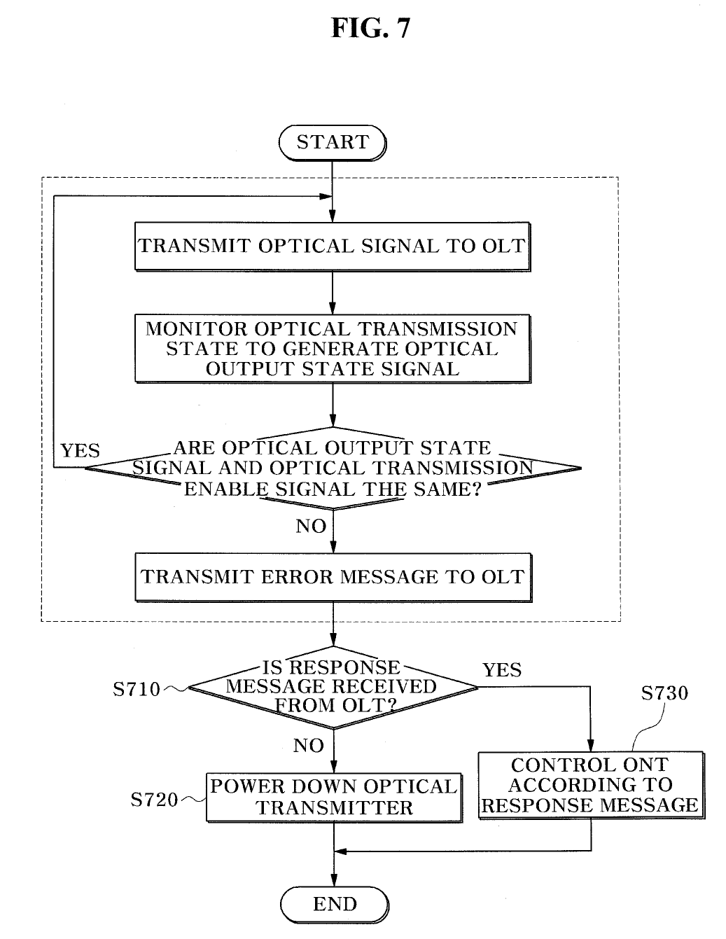

FIG. 7 is a flowchart illustrating a method of detecting an optical transmission error according to still another embodiment of the present disclosure. The method according to this embodiment includes a step (S710) in which the ONT 120 determines whether a response message to the error message is received from the OLT 110 when an optical transmission error is detected in step 530. Here, when the response message is not received, the ONT 120 powers down its optical transmitter 310 (S720). On the other hand, when the response message is received from the OLT 110, the ONT 120 is controlled according to the received response message (S730).

The above-described embodiments of the present disclosure have effects including the following merits. However, the embodiments of the present disclosure need not include all of the merits, and it is to be understood that the scope of the present disclosure is not limited by the merits.

In an embodiment of the present disclosure, a time for an OLT to detect a transmission error of an ONT is reduced. Thus, the OLT can rapidly cope with the error, and it is possible to provide stable service to users.

Also, in an embodiment of the present disclosure, when an error occurs, an ONT cuts off power supply of its optical transmitter, thereby preventing a communication problem from occurring at other ONTs even before an OLT takes action. Furthermore, in an embodiment of the present disclosure, even when an ONT cuts off power supply of its optical transmitter, an error message is transmitted to an OLT so that the OLT or a network administrator can correctly recognize details of the error and take appropriate steps.

The foregoing is illustrative of the present disclosure and is not to be construed as limiting thereof. Although numerous embodiments of the present disclosure have been described, those skilled in the art will readily appreciate that many modifications are possible in the embodiments without materially departing from the novel teachings and advantages of the present disclosure. Accordingly, all such modifications are intended to be included within the scope of the present disclosure as defined in the claims. Therefore, it is to be understood that the foregoing is illustrative of the present disclosure and is not to be construed as limited to the specific embodiments disclosed, and that modifications to the disclosed embodiments, as well as other embodiments, are intended to be included within the scope of the appended claims. The present disclosure is defined by the following claims, with equivalents of the claims to be included therein.

What is claimed is:

1. An optical network terminal (ONT) connected with an optical line termination (OLT) and constituting a passive optical network (PON), comprising:
an optical transmitter configured to transmit an optical signal to the OLT;
an error detector configured to detect an error of the optical transmitter; and
a controller configured to transmit an error message to the OLT through the optical transmitter when the error detector detects an error of the optical transmitter.

2. The ONT according to claim 1, wherein the error detector includes:
an optical transmission sensor configured to monitor the optical signal output from the optical transmitter to generate an optical output state signal; and
a signal comparator configured to compare the optical output state signal received from the optical transmission sensor and an optical transmission enable signal received from the controller to detect an error of the optical transmitter.

3. The ONT according to claim 1, wherein the controller powers down the optical transmitter when the error detector detects an error of the optical transmitter.

4. The ONT according to claim 1, further comprising an optical receiver configured to receive an optical signal from the OLT,
wherein the controller powers down the optical transmitter when the optical receiver cannot receive a response message to the error message.

5. A method for an optical network terminal (ONT) connected with an optical line termination (OLT) and constituting a passive optical network (PON) to detect an optical transmission error, comprising:
transmitting an optical signal to the OLT;
monitoring the transmitted optical signal to generate an optical output state signal;
comparing the generated optical output state signal and an optical transmission enable signal to detect the optical transmission error; and
transmitting an error message to the OLT when the optical transmission error is detected.

6. The method according to claim 5, further comprising powering down an optical transmitter of the ONT when the optical transmission error is detected.

7. The method according to claim 5, further comprising powering down an optical transmitter of the ONT when a response message to the error message is not received from the OLT.

8. The method according to claim 5, further comprising controlling the ONT according to a response message to the error message when the response message is received from the OLT.
